(19) United States
(12) Patent Application Publication
(10) Pub. No.: US 2006/0131781 A1
(43) Pub. Date: Jun. 22, 2006

(54) Method and apparatus for the manufacturing of decorative figures and the product thus obtained

(76) Inventors: Maria Natalia Bril Battaglia, Buenos Aires (AR); Marcelo Schuster, Buenos Aires (AR)

Correspondence Address: STEPHAN A. PENDORF, P.A., PENDORF & CUTLIFF, 5111 MEMORIAL HIGHWAY, TAMPA, FL, 33634, US

(21) Appl. No.: 11/013,644

(22) Filed: Dec. 16, 2004

(51) Int. Cl. B29C 39/10

(52) U.S. Cl. 264/259; 425/115

(57) ABSTRACT

A method and apparatus to obtain decorative figures in a material constituted either by self-supporting gel, wax, paraffin or silicone, which include the following steps: a) to mix the raw material in at least one container while said raw material is heated and until a paste is obtained, b) said material is passed though at least one nozzle by means of gravity, c) to drop the material on a first surface in motion, d) to transfer the material to a second surface in motion and e) to make the material move along the second surface in motion towards the internal part of the folds of a wrapping sheet.

### BACKGROUND OF THE INVENTION

The present invention relates to a method and apparatus for the manufacturing of decorative figures and the product thus obtained, in a material constituted either by self-supporting gel, wax, paraffin or silicone, and particularly it relates to a procedure and to the apparatus that carries out said procedure and to the decorative figure obtained by means of said procedure and said apparatus.

The material which is most used in the production of said figures is the self-supporting gel.

Due to the chemical composition of said material, it acts as a magnet or vent, which makes it able to adhere to a smooth surface without using an additional adhesive.

Such self-supporting gel decorative figures which has a laminar shape and irregular contours are manufactured in the following manner:

1) introducing the self-supporting gel and the coloring matter in a container; then its content is heated and mixed up;

2) once said mixture is homogeneous and at approximately 135° C. (275 F), the content is poured on smaller containers and then it is mannualy poured into open molds which define the different figures;

3) the molds are left to cool down until the figures can be removed without becoming deformed; and

4) finally, the figures are packed.

The molds are made out of plastic, metal or rubber.

When the figure has a discoidal or an irregular shape, instead of pouring the homogeneous mixture in molds, this is done directly on an smooth surface.

This handmade manner of obtaining the figures is slow and quite vague as regards the uniformity of the figures produced.

Using the method and apparatus of the present invention, the figures can be obtained in a faster and more uniform manner.

### MAIN OBJECT

The main object of the present invention is a method to obtain decorative figures in a material constituted either by self-supporting gel, wax, paraffin or silicone, the novelty of said method is that it includes the following steps: a) to mix the raw material in at least one container while said raw material is heated until a paste is obtained, b) by means of gravity, said material is passed through at least one nozzle, c) to drop the material on a first surface in motion, d) to transfer the material to a second surface in motion and e) to make the material move along the second surface in motion towards the internal part of the folds of a wrapping sheet.

In a preferred embodiment of the invention there are two of said containers and in each one the raw material of a different color is mixed, said dropping is intermittent and, after passing the surface through said nozzles, the material passes through a cooling area.

In a further preferred embodiment said dropping from a single container is continuous, and, after passing the surface through the nozzle, the material passes through a cooling area and then under a wheel with cutting shapes.

Still, in another preferred embodiment there are two of said containers, said first surface is a rotary one and has molds, the material is cooled in said molds by means of cooling elements and an arm provided with suction collects the material from the molds and puts said material on said second surface.

Another object of the invention is an apparatus to carry out the method, its novelty is that it includes at least one container with mixing paddles and heating means controlled by thermostats, under said container there is at least one nozzle through which the material—as a paste—flows, a first surface transports said material, cooling means located in an area through which said first surface passes, a second surface in motion located next to said first surface and dispensing means of a sheet forming a fold in which said material penetrates.

In another preferred embodiment of the apparatus according to the invention there are two containers, and each one contains a different mixture, said first surface is the superior part of a continuous conveyor belt and said second surface is another superior part of a continuous conveyor belt.

Still, in another preferred embodiment of the apparatus according to the invention said first surface is the superior part of a continuous conveyor belt, that downstream of said cooling means includes a wheel having on its surface a plurality of cutting elements of the material located on the belt and said second surface is another superior part of a continuous conveyor belt.

Another preferred embodiment of the apparatus according to the invention is that in which said first surface has a discoidal shape and rotates, with a plurality of molds on the same with their corresponding cooling means, at least one arm provided with suction which removes the material from the mold and then transfers said material to a second surface constituted by the superior part of a continuous conveyor belt.

Another object of the invention is a decorative figure obtained by means of the abovementioned method and apparatus with a substantially plane shape and is made of self-supporting gel.

Another object of the invention is a decorative figure obtained by means of the abovementioned method and apparatus with a substantially plane shape and is made of wax.

Another object of the invention is a decorative figure obtained by means of the abovementioned method and apparatus with a substantially plane shape and is made of paraffin.

Another object of the invention is a decorative figure obtained by means of the abovementioned method and apparatus with a substantially plane shape and is made of silicone.

### BRIEF DESCRIPTION OF THE DRAWINGS

The object as well as the preferred embodiments will be apparent and elucidated in the following description and with reference to the drawings, in which:

FIG. 1 is a diagram of an apparatus that carries out the method in accordance with the invention,

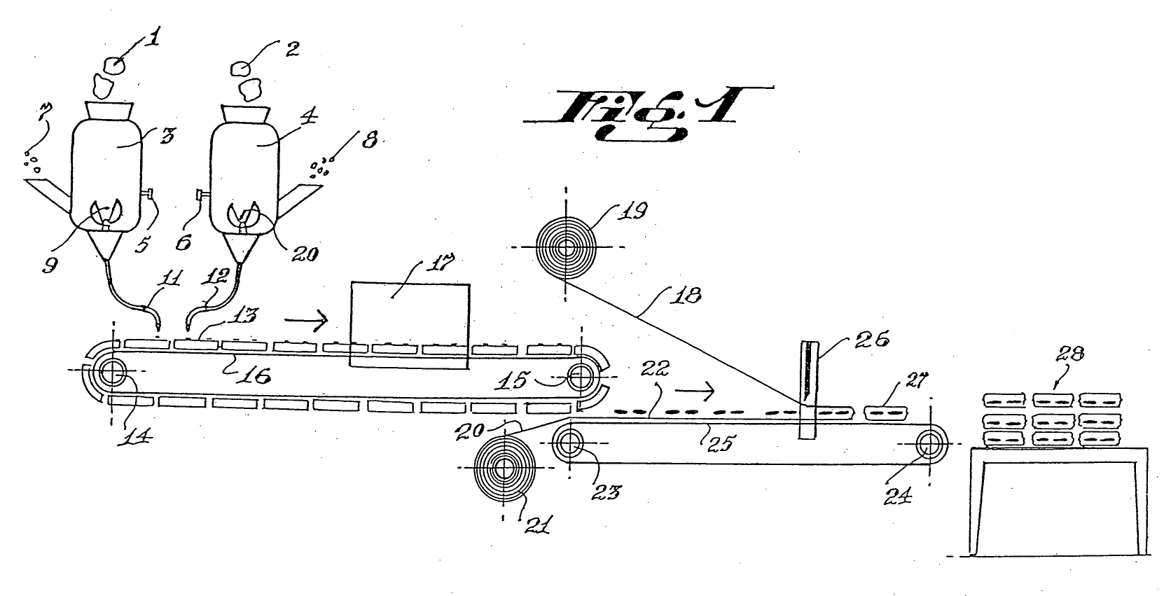

FIG. 2 is another diagram of an apparatus that carries out the method in accordance with the invention, and

FIG. 3 is another diagram of an apparatus that carries out the method in accordance with the invention.

### DETAILED DESCRIPTION OF THE PREFERRED EMBODIMENTS

As shown in the figures herein attached, in which the same means correspond with same references, the raw material (1) is introduced in the container (3) in order to obtain a color, and the raw material to obtain another color (2) is introduced in the container (4).

The anilines or essences (1) and (8) are also introduced in the containers (3) and (4) and by means of the mixers (9) and (10) they are heated and mixed until a pasty substance is obtained, in such a way that it can flow by means of gravity through the ducts (11) and (12).

The temperature of the mixtures in both containers is controlled by means of thermostats (5) and (6).

The pasty mixtures, at approximately 135° C. (275° F.), exit the end of the ducts (11) and (12) and drop in the open molds (13), and are carried by the belt (16) in the direction of the arrow, driven by the rollers (14) and (15).

The molds (13), transported by the belt (16), after receiving the material, pass by a cooling tunnel (17), and when reaching the roller (15), they drop, due to gravity, the cooled decorative figure.

The decorative figure falls on a wrapping sheet (18), (20) that is fed from the coils (19) and (21) and together with the conveyor belt (25) defines a plane surface in motion (22) that contains said figures and that is driven by the rollers (23) and (24).

Said wrapping sheet may be polyvinyl chloride or thermally formable polyvinyl chloride, and forms a fold that is cut and welded by a shear (26) in such a way that the figures are packed inside the packets (27) formed by said sheet (18), (20).

Finally the packets (27) are stored manually in the station (28).

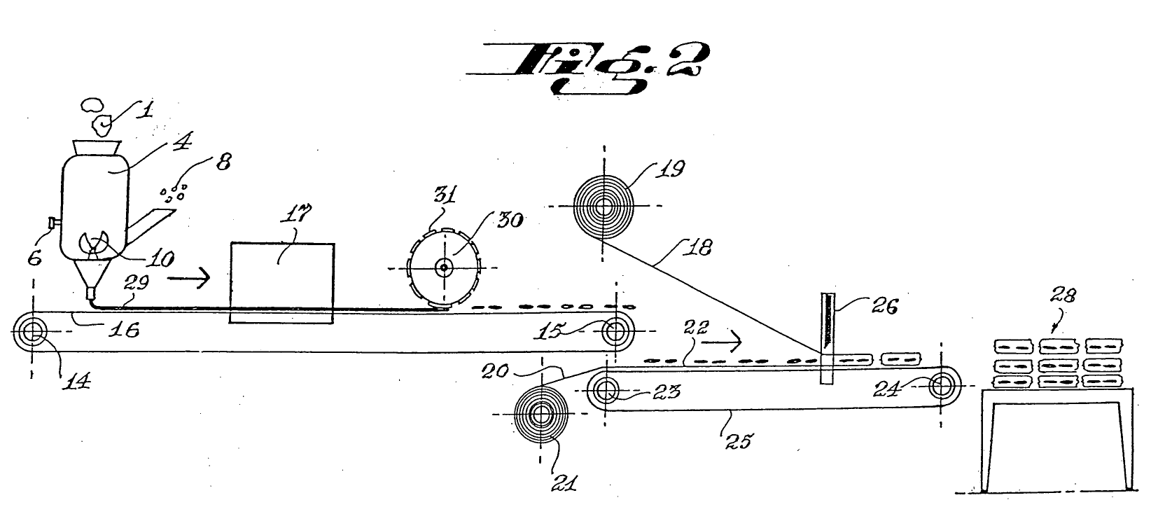

In the embodiment shown in FIG. 2, the arrangement has a single container (4) from which is delivered a continuous sheet (29) driven in the direction of the arrow on the belt (16) and after passing through the cooling tunnel (17), a wheel (30) with a plurality of cutting shapes (31), cuts the continuous sheet (29) in the various shapes producing said decorative figures.

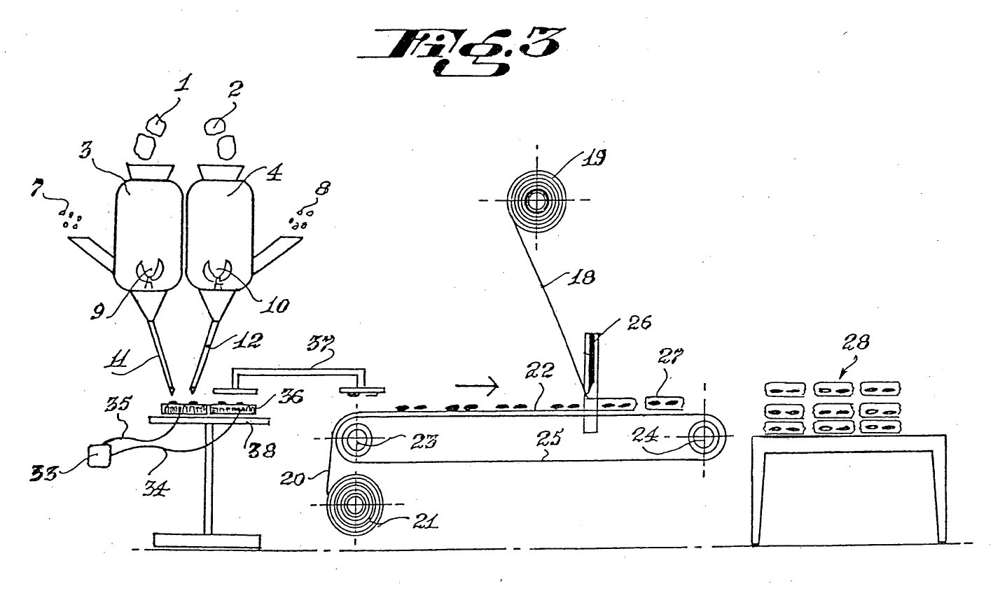

In the embodiment shown in FIG. 3, the material drops in the molds (36) arranged on a gyratory plate (38).

The molds (36) are cooled by means of a device (33) that sends water by pressure by means of the ducts (34) and (35).

An arm (37) collects the figures from the molds (36) by means of suction and deposits said figures on the belt (22)

The material in which the molds (13) and (36) are made is preferably plastic, metal, or rubber.

1) A method to obtain decorative figures in a material constituted either by self-supporting gel, wax, paraffin or silicone, wherein said method includes the following steps: a) to mix the raw material in at least one container while said raw material is heated until a paste is obtained, b) by means of gravity, said material is passed through at least one nozzle, c) to drop the material on a first surface in motion, d) to transfer the material to a second surface in motion and e) to make the material move along the second surface in motion towards the internal part of the folds of a wrapping sheet.

2) The method according to claim 1, wherein there are two of said containers and in each one the raw material of a different color is mixed, said dropping is intermittent and, after passing the surface through said nozzles, the material passes through a cooling area.

3) The method according to claim 1, wherein said dropping from a single container is continuous, and, after passing the surface through the nozzle, the material passes through a cooling area and then under a wheel with cutting shapes.

4) The method according to claim 1, wherein there are two of said containers, said first surface is a rotary one and has molds, the material is cooled in said molds by means of cooling elements and an arm provided with suction collects the material from the molds and puts said material on said second surface.

5) An apparatus to carry out the method according to claim 1, wherein it includes at least one container with mixing paddles and heating means controlled by thermostats, under said container there is at least one nozzle through which the material—as a paste—flows, a first surface transports said material, cooling means located in an area through which said first surface passes, a second surface in motion located next to said first surface and dispensing means of a sheet forming a fold in which said material penetrates.

6) The apparatus according to claim 5, wherein there are two containers, and each one contains a different mixture, said first surface is the superior part of a continuous conveyor belt and said second surface is another superior part of a continuous conveyor belt.

7) The apparatus according to claim 5, wherein said first surface is the superior part of a continuous conveyor belt, that downstream of said cooling means includes a wheel having on its surface a plurality of cutting elements of the material located on the belt and said second surface is another superior part of a continuous conveyor belt.

8) The apparatus according to claim 5, wherein said first surface has a discoidal shape and rotates, with a plurality of molds on the same with the corresponding cooling means, at least one arm provided with suction that removes the material from the mold and then transfers said material to a second surface constituted by the superior part of a continuous conveyor belt.

9) The apparatus according to claim 5 forms a decorative figure wherein it has a substantially plane shape and is made of self-supporting gel.

10) The apparatus according to claim 5 forms a decorative figure wherein it has a substantially plane shape and is made of wax.

11) The apparatus according to claim 5 forms a decorative figure wherein it has a substantially plane shape and is made of paraffin.

12) The apparatus according to claim 5 forms a decorative figure wherein it has a substantially plane shape and is made of silicone.

13) The method according to claim 1 forms a decorative figure wherein it has a substantially plane shape and is made of self-supporting gel.

14) The method according to claim 1 forms a decorative figure wherein it has a substantially plane shape and is made of wax.

15) The apparatus according to claim 5 forms a decorative figure wherein it has a substantially plane shape and is made of paraffin.

16) The method according to claim 1 forms a decorative figure wherein it has a substantially plane shape and is made of silicone.
